(19) United States
(12) Patent Application Publication
(10) Pub. No.: US 2021/0350744 A1
(43) Pub. Date: Nov. 11, 2021

(54) PIXEL DRIVING CIRCUIT AND DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Zhenfei CAI, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/625,717

(22) PCT Filed: Nov. 27, 2019
(86) PCT No.: PCT/CN2019/121182

§ 371 Date: Dec. 22, 2019

(30) Foreign Application Priority Data
Jul. 19, 2019 (CN) 201910652678.0

(51) Int. Cl. G09G 3/3208

(52) U.S. Cl. CPC G09G 3/3208; G09G 2330/021; G09G 2310/061; G09G 2320/045; G09G 2300/0842

(57) ABSTRACT

The present disclosure provides a pixel driving circuit and a display panel. The pixel driving circuit includes a reset unit, a compensation unit, and a driving unit. The reset unit provides a reset signal to the driving unit according to a first control signal, and the compensation unit provides a compensation signal to the driving unit according to a data signal. A first input terminal of the driving unit is connected to the reset unit, a second input terminal of the driving unit is connected to the compensation unit, a third input terminal of the driving unit is connected to a second control signal, and an output terminal is connected to a second power supply voltage.

### FIELD OF INVENTION

The present disclosure relates to the field of electronic display technologies, and more particularly, to a pixel driving circuit and a display panel.

### BACKGROUND OF INVENTION

Current display panels generally use a thin film transistor layer as a driving circuit of the display panels. Affected by manufacturing processes, transistor parameters, and circuit voltages, threshold voltages of different thin film transistors are often slightly different. At the same time, during circuit operation, voltage change of each node will also cause the threshold voltages of the thin film transistors to drift. Therefore, to eliminate a negative influence of the difference and change of the threshold voltage of the thin film transistor on the circuit, it is usually necessary to add a compensation module to the driving circuit.

FIG. 1 is a driving circuit commonly used in the prior art. Through a reset circuit and a compensation circuit located on both sides of the driving circuit, a correlation between the threshold voltage and the driving current is eliminated. However, a number of transistors and capacitors in this circuit is relatively large, and the time sequence is complicated, making it difficult to ensure accuracy of the compensation.

### SUMMARY OF INVENTION

The present disclosure provides a pixel driving circuit and a display panel, which can simplify a structure and a time sequence of the pixel driving circuit in the prior art.

To solve the above problems, the present disclosure provides a pixel driving circuit, comprising a reset unit, a compensation unit, and a driving unit, wherein

a first input terminal of the reset unit receives a reset voltage, a second input terminal of the reset unit receives a first control signal, an output terminal of the reset unit is connected to the driving unit, and the reset unit provides a reset signal to the driving unit according to the first control signal;

an input terminal of the compensation unit receives a data signal, an output terminal is connected to the driving unit, and the compensation unit provides a compensation signal to the driving unit according to the data signal; and

a first input terminal of the driving unit is connected to the reset unit, a second input terminal of the driving unit is connected to the compensation unit, a third input terminal of the driving unit is connected to a second control signal, and an output terminal is connected to a second power supply voltage.

According to another aspect of the present disclosure, the driving unit comprises a first thin film transistor, a second thin film transistor, and a third thin film transistor; wherein,

a source of the first thin film transistor receives to a first power supply voltage, a gate of the first thin transistor receives a second control signal, and a drain of the first thin transistor is connected to a source of the second thin film transistor;

a gate of the second thin film transistor receives the reset signal, and a drain of the second thin film transistor is connected to a source of the third thin film transistor; and

a gate of the third thin film transistor receives the second control signal, a drain of the third thin film transistor is connected to an input terminal of an organic light emitting diode to be driven.

According to an aspect of the present disclosure, the first thin film transistor, the second thin film transistor, and the third thin film transistor are N-type thin film transistors.

According to an aspect of the present disclosure, the compensation unit comprises a fourth thin film transistor and a storage capacitor; wherein

a source of the fourth thin film transistor receives the data signal, a gate of the fourth thin film transistor receives the first control signal, and a drain of the fourth thin film transistor is connected to an electrode plate of the storage capacitor and the drain of the second thin film transistor; and

another electrode plate of the storage capacitor is connected to the gate of the second thin film transistor.

According to an aspect of the present disclosure, the fourth thin film transistor is an N-type thin film transistor.

According to an aspect of the present disclosure, the aspect ratios of the first thin film transistor, the second thin film transistor, and the third thin film transistor are equal, and greater than an aspect ratio of the fourth thin film transistor.

According to an aspect of the present disclosure, the reset unit comprises a fifth thin film transistor and a sixth thin film transistor; wherein

a source of the fifth thin film transistor is connected to a source of the second thin film transistor, a gate of the fifth thin film transistor receives the first control signal, and a drain of the fifth thin film transistor is connected to the gate of the second thin film transistor; and

a source of the sixth thin film transistor is connected to the reset voltage, the gate of the sixth thin film transistor is connected to the first control signal, and a drain of the sixth thin film transistor is connected to the gate of the second thin film transistor.

According to an aspect of the present disclosure, the fifth thin film transistor and the sixth thin film transistor are N-type thin film transistors.

According to an aspect of the present disclosure, an aspect ratio of the fifth thin film transistor is equal to an aspect ratio of the sixth thin film transistor.

Correspondingly, the present disclosure further provides a display panel, the display panel including a pixel driving circuit including a reset unit, a compensation unit, and a driving unit, wherein,

a first input terminal of the reset unit receives a reset voltage, a second input terminal of the reset unit receives a first control signal, an output terminal of the reset unit is connected to the driving unit, and the reset unit provides a reset signal to the driving unit according to the first control signal;

an input terminal of the compensation unit receives a data signal, an output terminal is connected to the driving unit, and the compensation unit provides a compensation signal to the driving unit according to the data signal; and a first input terminal of the driving unit is connected to the reset unit, a second input terminal of the driving unit is connected to the compensation unit, a third input terminal of the driving unit is connected to a second control signal, and an output terminal is connected to a second power supply voltage.

The thin film transistors used in the pixel driving circuit of the present disclosure are all N-type thin film transistors. Compared with a driving circuit using both N-type thin film transistors and P-type thin film transistors, the manufacturing process of the driving circuit of the present disclosure is simpler. At the same time, the present disclosure only requires one storage capacitor, and the corresponding time sequence of circuit is simple and convenient for mass production.

### DESCRIPTION OF FIGURES

FIG. 1 is a circuit diagram of a pixel driving circuit in the prior art.

FIG. 2 is a circuit diagram of a pixel driving circuit in a specific embodiment of the present disclosure.

FIG. 3 is a time sequence diagram of the pixel driving circuit in FIG. 2.

### DETAILED DESCRIPTION OF PREFERRED EMBODIMENTS

The following descriptions of the embodiments are with reference to the attached figures to illustrate specific embodiments that can be implemented of the present disclosure. The directional terms mentioned in the present disclosure, such as “upper”, “lower”, “before”, “after”, “left”, “right”, “inside”, “outside”, “side”, etc., are only attached the directional terms used in the figures to explain and describe the present disclosure, not intend to limit the scope of the present disclosure. In the figures, the same structural components denoted by the same reference numerals.

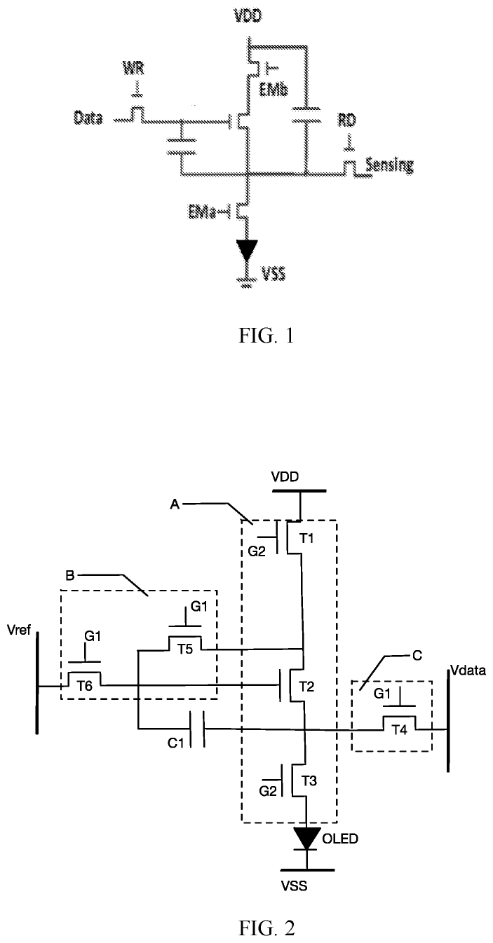

First, the prior art is briefly described. FIG. 1 shows a driving circuit commonly used in the prior art. The reset circuit and the compensation circuit located on both sides of the driving circuit eliminate the correlation between the threshold voltage and the driving current. However, the number of transistors and capacitors in this circuit is relatively large, and the time sequence is complicated, making it difficult to ensure the accuracy of the compensation.

Therefore, the present disclosure provides a pixel driving circuit and a display panel, which can simplify the structure and time sequence of the pixel driving circuit in the prior art.

Referring to FIG. 2, FIG. 2 is a circuit diagram of a pixel driving circuit in a specific embodiment of the present disclosure. The pixel driving circuit includes a reset unit B, a compensation unit C, and a driving unit.

In this embodiment, a first input terminal of the driving unit A is connected to the reset unit B, a second input terminal of the driving unit A is connected to the compensation unit C, a third input terminal of the driving unit A is connected to a second control signal G2, and an output terminal of the driving unit A is connected to a second power supply voltage VSS.

In this embodiment, the driving unit A includes a first thin film transistor T1, a second thin film transistor T2, and a third thin film transistor T3. The first input terminal of the driving unit A is a gate of the second thin film transistor T2, the second input terminal of the driving unit A is a drain of the second thin film transistor T2, and the third input terminal of the driving unit A is a gate of first thin film transistor T1 and a gate of the third thin film transistor T3. An organic light emitting diode (OLED) to be driven in this embodiment is connected to a drain of the third thin film transistor T3.

Specifically, a source of the first thin film transistor T1 is connected to a first power supply voltage VDD, the gate of first thin film transistor T1 receives a second control signal G2, and a drain of the first thin film transistor T1 is connected to a source of the second thin film transistor T2. The gate of the second thin film transistor T2 receives the reset signal, and the drain of the second thin film transistor T2 is connected to a source of the third thin film transistor T3. The gate of the third thin film transistor T3 receives the second control signal G2, and a drain of the third thin film transistor T3 is connected to an input terminal of the organic light emitting diode. An output terminal of the organic light emitting diode OLED is connected receives the second power supply voltage VSS.

In this embodiment, the first thin film transistor T1, the second thin film transistor T2, and the third thin film transistor T3 are N-type thin film transistors, and the light emitting diode is an organic light emitting diode. The first thin film transistor T1, the second thin film transistor T2, and the third thin film transistor T3 have the same aspect ratio.

An input terminal of the compensation unit C receives a data signal Vdata, an output terminal of the compensation unit C is connected to the driving unit, and the compensation unit C provides a compensation signal to the driving unit A according to the data signal Vdata. Referring to FIG. 2, the compensation unit C includes a fourth thin film transistor T4 and a storage capacitor C1. The input terminal of the compensation unit C is a source of the fourth thin film transistor T4, the output terminal of the compensation unit C is a drain of the fourth thin film transistor T4. The source of the fourth thin film transistor T4 receives the data signal Vdata, a gate of the fourth thin film transistor T4 receives a first control signal G1, and a drain of the fourth thin film transistor T4 is connected to an electrode plate of the storage capacitor C1 and the drain of the second thin film transistor T2. Another electrode plate of the storage capacitor C1 is connected to the gate of the second thin film transistor T2.

In this embodiment, the fourth thin film transistor T4 is an N-type thin film transistor. At the same time, the aspect ratios of the first thin film transistor T1, the second thin film transistor T2, and the third thin film transistor T3 are equal, and greater than an aspect ratio of the fourth thin film transistor T4.

A first input terminal of the reset unit B receives a reset voltage Vref, a second input terminal of the reset unit B receives the first control signal G1, an output terminal of the reset unit B is connected to the driving unit, and the reset unit B provides a reset signal to the driving unit A according to the first control signal G1. The reset unit B includes a fifth thin film transistor T5 and a sixth thin film transistor T6. The first input terminal of the reset unit B is a source of the sixth thin film transistor T6, the second input terminal of the reset unit B is a gate of the fifth thin film transistor T5 and a gate the sixth thin film transistor T6, and the output terminal of the reset unit B is a drain of the fifth thin film transistor T5.

The source of the fifth thin film transistor T5 is connected to the source of the second thin film transistor T2, the gate of the fifth thin film transistor T5 receives the first control signal G1, and the drain of the fifth thin film transistor T5 is connected to the gate of the second thin film transistor T2. The source of the sixth thin film transistor T6 is connected to the reset voltage Vref, the gate of the sixth thin film transistor T6 is connected to the first control signal G1, and the drain of the sixth thin film transistor T6 is connected to the gate of the second thin film transistor T2.

In this embodiment, the fifth thin film transistor T5 and the sixth thin film transistor T6 are N-type thin film transistors, and an aspect ratio of the fifth thin film transistor T5 is equal to an aspect ratio of the sixth thin film transistor T6.

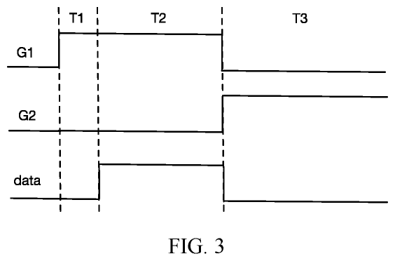

The operating process of the pixel driving circuit of the present disclosure is briefly described below. Referring to FIG. 3, FIG. 3 is a time sequence diagram of the pixel driving circuit in FIG. 2.

First, during the reset phase, the first control signal G1 is at a high electrical potential. At this time, turning on the fourth thin film transistor T4, the fifth thin film transistor T5, and the sixth thin film transistor T6, inputting a high electrical potential of the reset signal Vref into the gate and the drain of the second thin film transistor T2, and inputting a low electrical potential into the source of the second thin film transistor T2, to realize resetting of the second thin film transistor T2.

After that, in the compensation phase, the data signal Vdata is at a high electrical potential, turning on the second thin film transistor T2 due to the short-circuiting between the gate and the drain, and continuing to discharge electricity, so that the voltage between the gate and the drain gradually decreases. When the gate voltage Vg of the second thin film transistor T2 is equal to the threshold voltage Vth, turning off the second thin film transistor T2, at the same time, the gate voltage Vg=Vdata+Vth, to realize compensation for the second thin film transistor T2.

Finally, in the light-emitting phase, the first control signal G1 is at a low electrical potential. At this time, turning off the fourth thin film transistor T4, the fifth thin film transistor T5, and the sixth thin film transistor T6, turning on the second thin film transistor T2 and the third thin film transistor T3, and the drain current I of the second thin film transistor T2 of the driving tube conforms to the following formula, to realize the compensation for the threshold voltage.

$$\begin{matrix}l = {K ( Vgs - Vth )}^{2} \\ = {K ( Vdata - {V}_{OLED} + Vth - Vth )}^{2} \\ = {K ( Vdata - {V}_{OLED} )}^{2} .\end{matrix}$$

The thin film transistors used in the pixel driving circuit of the present disclosure are all N-type thin film transistors. Compared with a driving circuit using both N-type thin film transistors and P-type thin film transistors, the manufacturing process of the driving circuit of the present disclosure is simpler. At the same time, the present disclosure only requires one storage capacitor, and the corresponding time sequence of circuit is simple and convenient for mass production.

Accordingly, the present disclosure further provides a display panel, which includes the pixel driving circuit as described above.

In summary, although the preferable embodiments of the present disclosure have been disclosed above, the above preferred embodiments are not used for limit the present disclosure. Those skilled in the art can make various modifications without departing from the spirit and scope of the present disclosure, the protection scope of the present disclosure is defined by the scope of claims.

What is claimed is:

1. A pixel driving circuit, comprising a reset unit, a compensation unit, and a driving unit, wherein
a first input terminal of the reset unit receives a reset voltage, a second input terminal of the reset unit receives a first control signal, an output terminal of the reset unit is connected to the driving unit, and the reset unit provides a reset signal to the driving unit according to the first control signal;
an input terminal of the compensation unit receives a data signal, an output terminal of the compensation unit is connected to the driving unit, and the compensation unit provides a compensation signal to the driving unit according to the data signal; and
a first input terminal of the driving unit is connected to the reset unit, a second input terminal of the driving unit is connected to the compensation unit, a third input terminal of the driving unit is connected to a second control signal, and an output terminal of the driving unit is connected to a second power supply voltage.

2. The pixel driving circuit as claimed in claim 1, wherein the driving unit comprises a first thin film transistor, a second thin film transistor, and a third thin film transistor; wherein,
a source of the first thin film transistor is connected to a first power supply voltage, a gate of the first thin film transistor receives the second control signal, and a drain of the first thin film transistor is connected to a source of the second thin film transistor;
a gate of the second thin film transistor receives the reset signal, and a drain of the second thin film transistor is connected to a source of the third thin film transistor; and
a gate of the third thin film transistor receives the second control signal, and a drain of the third thin film transistor is connected to an input terminal of an organic light emitting diode to be driven.

3. The pixel driving circuit as claimed in claim 2, wherein the first thin film transistor, the second thin film transistor, and the third thin film transistor are N-type thin film transistors.

4. The pixel driving circuit according to claim 3, wherein the compensation unit comprises a fourth thin film transistor and a storage capacitor; wherein
a source of the fourth thin film transistor receives the data signal, a gate of the fourth thin film transistor receives the first control signal, and a drain of the fourth thin film transistor is connected to an electrode plate of the storage capacitor and the drain of the second thin film transistor; and
another electrode plate of the storage capacitor is connected to the gate of the second thin film transistor.

5. The pixel driving circuit as claimed in claim 4, wherein the fourth thin film transistor is the N-type thin film transistor.

6. The pixel driving circuit as claimed in claim 4, wherein aspect ratios of the first thin film transistor, the second thin film transistor, and the third thin film transistor are equal, and greater than an aspect ratio of the fourth thin film transistor.

7. The pixel driving circuit as claimed in claim 2, wherein the reset unit comprises a fifth thin film transistor and a sixth thin film transistor; wherein
a source of the fifth thin film transistor is connected to the source of the second thin film transistor, a gate of the fifth thin film transistor receives the first control signal, and a to drain of the fifth thin film transistor is connected to the gate of the second thin film transistor; and
a source of the sixth thin film transistor is connected to the reset voltage, a gate of the sixth thin film transistor is connected to the first control signal, and a drain of the sixth thin film transistor is connected to the gate of the second thin film transistor.

8. The pixel driving circuit as claimed in claim 7, wherein the fifth thin film transistor and the sixth thin film transistor are N-type thin film transistors.

9. The pixel driving circuit as claimed in claim 2, wherein an aspect ratio of the fifth thin film transistor is equal to an aspect ratio of the sixth thin film transistor.

10. A display panel, comprising a pixel driving circuit, the pixel driving circuit comprising a reset unit, a compensation unit, and a driving unit, wherein,
a first input terminal of the reset unit receives a reset voltage, a second input terminal of the reset unit receives a first control signal, an output terminal of the reset unit is connected to the driving unit, and the reset unit provides a reset signal to the driving unit according to the first control signal;
an input terminal of the compensation unit receives a data signal, an output terminal of the compensation unit is connected to the driving unit, and the compensation unit provides a compensation signal to the driving unit according to the data signal; and
a first input terminal of the driving unit is connected to the reset unit, a second input terminal of the driving unit is connected to the compensation unit, a third input terminal of the driving unit is connected to a second control signal, and an output terminal of the driving unit is connected to a second power supply voltage.
